(19) United States
(12) Patent Application Publication
(10) Pub. No.: US 2014/0017335 A1
(43) Pub. Date: Jan. 16, 2014

(54) METHOD FOR MANUFACTURING ANTIMICROBIAL ACRYLIC MATERIALS

(71) Applicants: Dimo K. Dimov, Branford, CT (US); Lawrence N. Gabriel, E. Stroudsburg, PA (US); Florian Lyon, Lincoln, CA (US); Christopher R. Spain, Wethersfield, CT (US); Peter D. Colburn, Guilford, CT (US); Craig T. Schmidter, Middlebury, CT (US); Zhen Zhu, Cheshire, CT (US)

(72) Inventors: Dimo K. Dimov, Branford, CT (US); Lawrence N. Gabriel, E. Stroudsburg, PA (US); Florian Lyon, Lincoln, CA (US); Christopher R. Spain, Wethersfield, CT (US); Peter D. Colburn, Guilford, CT (US); Craig T. Schmidter, Middlebury, CT (US); Zhen Zhu, Cheshire, CT (US)

(73) Assignee: EVONIK RÖHM GmbH, Darmstadt (DE)

(21) Appl. No.: 13/984,167

(22) PCT Filed: Feb. 7, 2012
(86) PCT No.: PCT/EP2012/052030

§ 371 Date: Oct. 4, 2013

Related U.S. Application Data
(60) Provisional application No. 61/440,177, filed on Feb. 7, 2011.

(51) Int. Cl. A01N 59/16

(52) U.S. Cl. CPC A01N 59/16
USPC 424/618

(57) ABSTRACT

Acrylic materials with antimicrobial activity are tumble blended, melted and extruded through an extruder. The resulting polymer compounds include an acrylic resin, such as methylmethacrylate polymers, copolymers and multipolymers, and blends thereof, silver-containing antimicrobial additives; and optional additives such as impact modifiers, flow promoters, stabilizers and coloring agents. The properties of the acrylic materials, especially the antimicrobial performance, are strongly dependent on the manufacturing process conditions, including feed resins pre-drying, residual moisture content, screw speed and melt temperature. The materials composition and manufacturing procedures are equally significant.

### FIELD OF THE DISCLOSURE

Disclosed herein is a process for manufacturing acrylic compounds and articles thereof such as sheet, film, rods, tubes and other extruded profiles and/or downstream articles, that exhibit antimicrobial activity. The process employs compositions based on acrylic resins, both standard and impact modified, including multipolymer resins and polymer blends, with silver containing antimicrobial additives and optional components like flow promoters, stabilizers, colorants, etc. More specifically, there are disclosed processing conditions for enhanced antimicrobial performance and enhanced optical performance. The antimicrobial resins and downstream articles can find a variety of uses, including medical and consumer applications.

### BRIEF DESCRIPTION OF ART

Acrylic is widely used in consumer and medical applications. Acrylic polymer provides a transparent or translucent durable product characteristic with desirable appearance, substantial abrasion-resistance, chemical resistance and colorability. Acrylic materials are incorporated into bathtubs, showers, whirlpools, bathroom and kitchen flooring and paneling used in homes, hotels, hospitals, restaurants and other residential or commercial environments. These acrylic based products are under constant exposure to bacteria, fungi and microbes that exist in their respective environments and there is a wide range of consumer and medical products that require antimicrobial performance.

In the medical industry, plastics usage is continuously increasing. A high rate of post-operative hospital infections, estimated to be 5-10% of hospital patients in the United States, prolongs infected patients' hospital stays by an average of 4-5 days, and increases the cost of hospitalization. Thus, the medical industry is challenged to develop plastics materials with good antimicrobial performance.

Antimicrobial technology for polymers is typically based on additives, either organic or inorganic. Representative organic additives are alcohol-, chlorine-, and ammonium-based organic ingredients that have found broad use since a couple of 1964 patents, drawn to the antimicrobial agents triclosan and brominated salicylanilides. More recently, attempts were made to incorporate organic additives into polymeric substrates. International patent publication WO 2000/014128 discloses acrylic polymers having antimicrobial characteristics by incorporating antimicrobial agents that exhibit controlled migration through the acrylic polymer until a point of equilibrium is reached. U.S. Pat. No. 7,579,389 discloses that while inorganic antimicrobial agents, such as silver and copper tend to discolor thermoformed articles, organic additives such as isothiazoline, an oxathiazine, an azole, and mixtures thereof may be combined with an acrylic precursor solution. However, low thermal stability and toxicity of degradation products make these materials less suitable for the medical industry.

U.S. Pat. Nos. 6,146,688 and 6,572,926 disclose a polymer technology for an organic antimicrobial additive sold under the trademark BIOSAFE (Biosafe, Inc., Pittsburgh, Pa.). The inventions evolved as a method of imparting antimicrobial properties in polymeric substrates based on the addition of quaternary ammonium salts. This technology provides permanent antimicrobial activity while eliminating common problems like discoloration, opacity and concerns about migrating out of the plastic. However, due to high bacterial concentration environment for medical devices, further improvement on efficacy (killing rate) performance is needed.

Representative inorganic antimicrobial products are based on the oligodynamic effect of metal ions, such as aluminum, copper, iron, zinc, and especially silver. Silver-based antimicrobial technology is highly effective and has been used in wound management and as additives in coatings since the 1960's. Silver antimicrobials for plastics were introduced in the 1990's and today are broadly used in materials for medical devices and public device applications. One conventional approach for obtaining antimicrobial medical devices is the deposition of metallic silver directly onto the surface of the substrate, for example, by vapor coating, sputter coating, ion beam coating, deposition or electrodeposition of silver from solution. U.S. Pat. No. 6,162,533 discloses a transparent base sheet coated with a radiation-cured acrylate coating layer that includes various antimicrobial agents such as a silver based inorganic antimicrobial agent carried on zirconium or calcium phosphate, silica gel, glass powder, and other carriers. Coating techniques suffer drawbacks, such as poor adhesion, lack of coating uniformity, secondary processing and a need for special processing conditions. In addition, it is difficult to adequately coat hidden or enclosed areas.

In recent years, attempts have been made to compound inorganic antimicrobial additives into different polymers. Early examples disclosed in U.S. Pat. No. 5,244,667 utilize the large surface area of porous silica gel coated with alumosilicate antimicrobial coat. Examples are given with several polymer classes, including PVC (polyvinyl chloride), polypropylene, HDPE (high density polyethylene), and polystyrene. A recognized disadvantage is the discoloration seen with the compositions when molded under heating. U.S. Pat. No. 5,827,524 claims to have resolved this issue, disclosing crystalline silicon dioxide antimicrobial compositions of improved color stability and good antimicrobial activity containing silver ions and one or two optional metal ions from the group of zinc and copper. Yet, the supporting data fall short of demonstrating the high standard of color stability required for optical material grades. A broad spectrum of thermoplastic and thermosetting polymers is listed including acrylic resins. U.S. Pat. No. 7,541,418 discloses a thermoplastic polycarbonate molding compound containing an antimicrobial compound, AgₐM¹_{b}M²₂(PO₄)₃, where M¹ is at least one ion selected from the group consisting of alkali metal ions, alkaline earth metal ions, ammonium ion and hydrogen ion. M² is a tetravalent metal selected from the group of Ti, Zr and Sn. U.S. Pat. Nos. 6,939,820 and 7,329,301 also disclose silver antimicrobial additives for such purposes. Each of U.S. Pat. Nos. 7,579,389; 7,541,418; 5,827,524; 6,593,260, 6,939,820 and 7,329,301 are incorporated by reference herein in their entireties.

An objective is to provide a simple and cost effective method to produce antimicrobial acrylic materials without the above mentioned drawbacks.

### BRIEF SUMMARY

The present disclosure provides a method to produce antimicrobial acrylic materials under controlled process conditions with surprisingly enhanced efficacy and optical performance. More specifically, the disclosure relates to processing conditions such as melt blending equipment, screw configuration, residence time, screw speed, melt temperature range and moisture content of the melt pool to optimize the antimicrobial performance and optical performance.

The antimicrobial formulations disclosed herein are broadly based on a range of acrylic compounds including PMMA, MMA copolymers and multipolymers, impact modified acrylic compounds and alloys thereof. The antimicrobial technology is based on a variety of commercially available silver-based additives, e.g. Bactiglas, NanoSilver, lonpure, Zeolite, SelectSilver, AlphaSan, etc. The content of antimicrobial additive ranges from about 0.1% by weight to about 10% by weight of the entire composition.

### IN THE DRAWINGS

FIG. 1 graphically illustrates the effect of additive loading on the silver release rate.

FIG. 2 graphically illustrates the effects of barrel temperature and screw speed on the release rate.

FIG. 3 graphically illustrates the effect of barrel temperature on the optical properties of an injection molded material.

### DETAILED DESCRIPTION

In a first aspect, the present description provides a method for producing antimicrobial acrylic materials through melt blending of polymers, process aids and antimicrobial additives under controlled process conditions with the optimum antimicrobial and optical performance. The acrylic materials produced have antimicrobial characteristics that inhibit bacterial, fungal, microbial and other pathogen or non-pathogen growth.

The antimicrobial formulations are based on a range of acrylic compounds including PMMA (poly(methyl methacrylate)), MMA(methyl methacrylate) copolymers and multipolymers, impact modified acrylic compounds and alloys thereof. The resin components utilized in the invention contain additives, including resins and compositions imparting impact strength, such as low Tg polymers and copolymers of aliphatic esters of acrylic acid, polymers and copolymers of 1,3-butadiene, styrene/butadiene, styrene/isoprene and styrene/ethylene-butylene copolymers, EPDM (ethylene propylene diene monomer) rubbers, polyisobutylene, polyurethane and silicone rubbers.

The antimicrobial products are used in applications including but not limited to medical devices and accessories, where typical examples are check valves, luer connectors, filter housings, spikes, Y-sites, measuring cups, etc., and consumer applications like vacuum cleaners, paper towel dispensers, hand dryers, bathtubs, shower stalls, bathroom and kitchen flooring, etc. Methods of manufacture include but are not limited to, molding and extrusion compounds, extruded sheet, and thermoformed and fabricated articles thereof, acrylic film and foam products, and extruded profiles.

Acrylic may be prepared by various methods including bulk, solution, emulsion, suspension and granulation polymerization. This polymer may also be obtained in liquid monomer or fully polymerized beads, sheets, panels or rods. After the acrylic polymer is prepared, the acrylic polymer may be processed by casting, pouring, sheet thermoforming, extrusion, calendaring, coating, brushing, spraying and machining with conventional tools to form a desired end product.

The acrylic polymers could be also impact modified PMMA and impact modified acrylic multipolymers. Examples of the rubbery reinforcing portion of such systems include such as polybutadienes, poly(styrene/butadienes), poly(methylmethacrylate/butadienes), polyisoprenes, polyisobutylenes, poly(isobutylene/isoprene) copolymers, poly(acrylonitrile/butadienes), polyacrylates, polyurethanes, neoprene, silicone rubbers, chlorosulfonated polyethylene, ethylene-propylene rubbers, and other such rubbery materials. rubbers, chlorosulfate polyethylene, ethylene-propylene rubbers, and other such rubbery materials.

Grafted onto the above rubbers may be the monomers detailed below for the resin phase. The monomers to be grafted must be compatible with the particular monomers used in the resin phase for a particular composition. Preferably, the same monomers are used in both. By “compatible” it is meant polymers which show a strong affinity for each other such that they can be dispersed into one another in small domain sizes. The smaller the domain sizes, the more compatible are the polymers. Further explanation of compatibility may be found in Advances in Chemistry Series, No. 99, “Multi-Component Polymer Systems”, edited by R. F. Gould, 1971, incorporated herein by reference.

The resin phase is any polymer or copolymer which is compatible with the grafted rubber phase. Examples of suitable monomers include: acrylates, methacrylates, nitriles, styrenes, vinyl/ethers, vinyl halides and other similar monovinyl compounds. Particularly suitable monomers include methylacrylate, ethylacrylate, propylacrylate, methylmethacrylate, ethylmethacrylate, propylmethacrylate, acrylonitrile, methacrylonitrile, styrene, .alpha.-methylstyrene, butyl vinyl ether, and vinyl chloride.

Preferably, for this invention, the rubber phase is polybutadiene grafted with methylmethacrylate, styrene, and optionally methylacrylate, ethylacrylate, or acrylonitrile.

Preferably, the resin phase is a terpolymer of methylmethacrylate, styrene, and optionally methylacrylate, ethylacrylate, or acrylonitrile.

Most preferably, the molding compositions are prepared from a graft polybutadiene phase and a polymeric resin phase where the polybutadiene fraction of the graft polybutadiene phase is calculated to be 5 to 25% by weight of the total molding composition. The polymeric resin phase contains about 60 to 80 parts of methylmethacrylate, 15 to 30 parts of styrene, and 0 to 15 parts of methylacrylate, ethylacrylate or acrylonitrile. The graft polybutadiene is polybutadiene grafted with methylmethacrylate, styrene and optionally either methylacrylate, ethylacrylate or acrylonitrile where the overall ratio of polybutadiene to graft monomers ranges from about 1:1 to about 6:1. The graft monomers are used in a ratio of from about 60 to 85 parts of methylmethacrylate, 15 to 30 parts of styrene and 0 to 15 parts of methylacrylate, ethylacrylate or acrylonitrile. The grafted polybutadiene is essentially uniformly distributed in the resin phase and is relatively non-agglomerated, i.e., it has essentially no aggregates greater than about 1 micron.

The compositions may be produced by blending the resinous terpolymer, which may be prepared by a free radical initiated reaction in the presence of a solvent and in a two-stage system whereby the monomer blend is charged to a first reactor and polymerized to about 20 to 40% solids and then in a second reactor where complete conversion is carried out, with the grafted polybutadiene in the appropriate amounts. Alternatively, the instant compositions may be prepared by interpolymerization of all the monomers, using a suitable emulsifier, in the presence of the polybutadiene rubber, preferably in latex form, under the conditions of grafting as discussed below.

Any known procedure may be utilized to produce the resin phase. It is preferred, however, that the resin phase be produced by blending the appropriate concentration of monomers in a solvent such as toluene at about a 60 to 80% monomers concentration. A suitable initiator such as benzoyl peroxide, di-t-butyl peroxide and the like may be added in the presence of a molecular weight control additive such as an alkyl mercaptan e.g., n-dodecyl mercaptan, n-octyl mercaptan, t-dodecyl mercaptan, benzyl mercaptan and the like. As mentioned above, this polymerization is preferably conducted in a two-stage system whereby the monomer solution is charged to the first stage reactor and polymerized at from about 80° C. to 110° C. for from about 12 to 24 hours. The rate of conversion is preferably adjusted to from about 1 to 3% solids per hour. The first stage polymer is then preferably transferred to a second stage such as a plug flow reactor where complete conversion of the monomer to polymer is carried out. The final solids content generally ranges from about 60 to 70%. Initiators may be used in amounts ranging from about 0.01 to 5.0 percent by weight, based on the weight of the monomers. The molecular weight control additive can be used in like amounts, by weight, again based on the weight of the monomers.

There may be added to the resin phase, after or during formation, such additives as heat and light stabilizers, antioxidants, lubricants, plasticizers, pigments, fillers, dyes and the like. Other additives include antioxidants, flow promoters, mold releases, colorants, UV-stabilizers, and formulations imparting gamma stability, resistance to chemicals and/or static dissipative properties.

The grafted rubber phase is prepared by a sequential and controlled addition of monomers process which inhibits agglomeration and/or aggregation of the rubber particles. In the process which is essentially a standard free radical initiation polymerization, wherein at least the monomer having the best compatibility as a polymer to that of the resin phase is added to the rubber latex and any other monomers which are also being grafted onto the rubber, conventional initiators and other polymerization components are used.

While not being bound by any theory it is believed that the non-agglomeration is caused by putting an essentially uniform shell of resin around the rubber particles wherein the outer layer of the shell is composed primarily of the controllably added monomer.

The monomer being controllably added should be added over a period of at least 15 minutes, preferably at least 1 hour, and most preferably about 1 to 3 hours, with the grafting reaction occurring during the addition and preferably allowed to continue thereafter for about one hour. The initiator when it is a redox type may be included in the reactor initially, it may be added simultaneously with the controlled monomer either in the same stream or in a separate stream; or ultraviolet light may be used. Generally, the initiator is used in an amount up to about four times the standard amounts used in U.S. Pat. No. 4,085,166. When the initiator is added at the same time as the controlled monomer either the oxidant or reductant portion may be placed in the reactor initially and only the other portion need be controllably added. The reaction is conducted in the pH range of about 6.0 to 8.5 and in the temperature range of about room temperature to about 65° C., though neither has been found to be critical to the present invention.

Examples of suitable redox initiator systems include: t-butyl hydroperoxide, cumene hydroperoxide, hydrogen peroxide, or potassium persulfate-sodium formaldehyde sulfoxylate-iron; hydroperoxides-tetraethylene pentamine or dihydroxyacetone; hydroperoxides-bisulfite systems; and other such well-known systems.

The resinous phase and the rubbery phases may be blended together in any known manner such as by utilizing a ball mill, hot rolls, emulsion blending, or the like.

It is preferred that the blending operation be carried out in a devolatilizer-extruder in a manner disclosed at column 3, lines 3 to 72 of the above-mentioned U.S. Pat. No. 3,354,238, which section thereof is hereby incorporated herein by reference.

The acrylic polymers could be multipolymers. The compositions comprise a blend of from about 70 to about 90%, preferably from about 75 to about 85% of a resinous terpolymer of from about 65 to 75 parts of methylmethacrylate, from about 18 to about 24 parts of styrene and from about 2 to about 12 parts of ethylacrylate and, correspondingly, from about 5 to about 30%, preferably from about 10 to about 25%, of polybutadiene grafted with from about 17 to 22 parts of methylmethacrylate, 4 to 7 parts of styrene and 0 to 3 parts of ethylacrylate.

The methyl methacrylate copolymer employed in the compositions will contain a predominant amount, e.g., about 50 to about 90 parts by weight, preferably 50 to 80 parts by weight, of methyl methacrylate and a minor amount, e.g., about 10 to about 50 parts by weight, preferably 20 to 40 parts by weight, of one or more ethylenically unsaturated monomers such as styrene, acrylonitrile, methyl acrylate, ethyl acrylate and mixtures thereof. Preferably, the ethylenically unsaturated monomer comprises a mixture of styrene and acrylonitrile or styrene and ethyl acrylate wherein the styrene is present in the copolymer in an amount of about 10 to about 40, preferably 15 to 30, parts by weight and the acrylonitrile is present in the copolymer in an amount of about 5 to about 30, preferably 5 to 20, parts by weight, based on the weight of the copolymer or the ethyl acrylate is present in the copolymer in an amount of about 3 to about 10, preferably 5 to 10 parts by weight, based on the weight of the copolymer. Such methyl methacrylate copolymers are well known in the prior art, e.g., U.S. Pat. Nos. 3,261,887; 3,354,238; 4,085,166; 4,228,256; 4,242,469; 5,061,747; and 5,290,860.

Preferably, the methyl methacrylate copolymer will have a weight average molecular weight of at least about 50,000, e.g., about 100,000 to about 300,000 and a glass transition temperature of at least about 50° C. Typically, the methyl methacrylate copolymer will have a refractive index of about 1.50 to about 1.53, preferably 1.51 to 1.52, (as measured in accordance with ASTM D-542).

Preferably, the composition includes an impact modifier having a refractive index within about 0.005 units, preferably within 0.003 units, of the refractive index of the methyl methacrylate copolymer (as measured in accordance with ASTM D-542). Typically, the impact modifier will be present in an amount of about 2 to about 30, preferably 5 to 20 wt. %, based on the weight of the copolymer plus the polyetheresteramide plus the impact modifier.

Preferable impact modifiers for incorporation in the multipolymer compositions of the present invention include copolymers of a conjugated diene rubber grafted with one or more ethylenically unsaturated monomers as well as acrylic copolymers having a core/shell structure.

In the case where the impact modifier comprises a copolymer of the conjugated diene rubber, the rubber is preferably polybutadiene which is present in an amount of about 50 to about 90, preferably 70 to 80, parts by weight, based on the weight of the impact modifier, and the ethylenically unsaturated monomer(s) grafted onto the polybutadiene rubber is typically present in an amount of about 10 to about 50, preferably 15 to 40, parts by weight, based on the weight of the impact modifier. Typically, the ethylenically unsaturated monomer to be grafted onto the conjugated diene rubber will be a C₁-C₄ alkyl acrylate such as methyl acrylate, ethyl acrylate, propyl acrylate or butyl acrylate; a C₁-C₄ alkyl methacrylate such as methyl methacrylate, ethyl methacrylate, propyl methacrylate or butyl methacrylate; a styrene such as styrene or .alpha.-methyl styrene; a vinyl ether; a vinyl halide such as vinyl chloride; a nitrile such as acrylonitrile or methacrylonitrile; an olefin or mixtures thereof. Preferably the ethylenically unsaturated monomer(s) to be grafted onto the conjugated diene rubber comprises a monomer mixture of methyl methacrylate and styrene, with the methyl methacrylate:styrene ratio being in the range of about 2:1 to about 5:1, preferably 2.5:1 to 4.5:1.

In the case where the impact modifier comprises an acrylic copolymer having a core/shell structure, it is preferred that the core/shell structure comprises a core of a cross-linked poly(alkylmethacrylate) or a cross-linked diene rubber and a shell of a copolymer of an alkyl acrylate (e.g., methyl acrylate) and styrene. It is further preferred that the poly(alkyl-methacrylate) comprises poly(methyl methacrylate), the diene rubber comprises polybutadiene rubber and the alkyl acrylate comprises butyl acrylate. It is especially preferred that there is an additional outer shell of poly(methyl methacrylate) in addition to the shell of the alkyl acrylate/styrene copolymer.

The acrylic polymers also include alloys based on commercial modified acrylic multipolymers, such as XT® and Cyrolite® multipolymers (Evonik Cyro LLC, Parsippany, N.J.) when blended with polycarbonates produce materials having very high impact strengths with notched Izod values superior to polycarbonate in inch thick sections. These alloys also offer a good balance of mechanical strength, heat resistance, and processability which make them commercially attractive. Use of the high flow versions of the above-identified modified acrylic multipolymers, has resulted in even higher notched Izods in ⅛ inch thick sections which results are also superior to those of pure polycarbonates. These latter materials have outstanding processability and maintain a good balance of mechanical strength and heat resistance.

Alloys of the commercial rubber modified acrylic multipolymers and polycarbonates, according to the invention, can range from a ratio by weight from about 20:80 to about 80:20. The graft rubber to polymer ratio in the rubber modified acrylic multipolymers used in the invention ranges by weight from about 5:95 to about 25:75. The rubber, preferably, comprises about 14 percent of the multipolymer alloy. The multipolymer component of the alloy comprises from about 60 to about 80 parts by weight of methylmethacrylate, about 15 to about 30 parts by weight of styrene, and up to about 15 parts by weight of methylacrylate, ethylacrylate, or acrylonitrile. The graft monomers in the rubber modified acrylics of the invention comprise by weight from about 60 to about 85 parts of methylmethacrylate, about 15 to about 30 parts styrene, and up to about 15 parts of methylacrylate, ethylacrylate, or acrylonitrile. The weight ratio of rubber to graft monomers in said graft rubber ranges from about 1:2 to about 6:1.

The rubber modified acrylic multipolymers used include an unsaturated rubber, polybutadiene being preferred. In practice, commercial rubber modified acrylic multipolymers having a weight ratio of rubber to graft monomers of about 3:1 may be utilized in the invention.

The rubber modified acrylic alloys sold under the trademarks XT® and Cyrolite® by Evonik Cyro LLC utilized in this invention are manufactured in accordance with one or more of the following U.S. Pat. Nos. 3,261,887, 3,354,238, 4,085,166, 4,228,256, and 4,242,469 which patents are incorporated herein by reference. The compositions of the rubber modified acrylic multipolymers are particularly set forth in the above noted U.S. Pat. No. 4,228,256 wherein the ratios of the components of the rubber modified acrylic multipolymers given above may be found.

The multipolymer component of the commercially available alloys XT® alloys is a terpolymer of about 60% to about 70% of MMA, about 20% styrene, and about 10% to about 20% acrylonitile. The multipolymer component of the commercially available Cyrolite® alloys is a terpolymer of about 5% ethylacrylate, about 15% to about 25% styrene, and 70% to about 80% MMA. These alloys all contain about 14% rubber and their rubber graft and multipolymer components are substantially free of .alpha.-methylstyrene, (meth)acrylonitrile, maleic anhydride, and n-substituted maleimide.

The above ratios and percentages are all by weight.

Various polycarbonates may be used in the invention, such as Lexan® 181 polycarbonate available from General Electric Company (Stamford, Conn.), Calibre® 302-60 polycarbonate available from The Dow Chemical Company (Midland, Mich.), and Makrolon® 3103 available from Mobay Chemical Company (Pittsburgh, Pa.). These materials may be made in accordance with U.S. Pat. Nos. 4,885,335 and 4,883,836 which are incorporated herein by reference or in accordance to the prior art cited in those patents.

Additives with antimicrobial effect are selected from a group that includes silver-based antimicrobial agents, including silver containing glass powders, silver zeolite products, silver containing compounds of tetravalent metals, e.g. titanium, zirconium and tin, antimicrobial glass compositions, and nanosilver additives. The antimicrobial additive is present in an amount of between 0.1 to 10%, preferably 0.2 to 5.0%, most preferably 0.3 to 2.5% by weight of the final composition.

The antimicrobial material can be used to produce molding compound by an extrusion method. The antimicrobial compound is first dispersed by known methods into an acrylic carrier resin having a controlled moisture content. By weight, the resin contains no more than 1% moisture. Preferably, the moisture content is less than 0.4% and, most preferably, less than 0.1%. The resin may be made by any conventional method of polymerization including, but not limited to, emulsion, bulk, solution, bead and suspension methods. This resin can then be fed to an extruder along with the main acrylic resin and then pelletized to form the molding compound product. The extruder may be either a single screw extruder or a double screw extruder. The extruder screw speed is no more than 250 revolutions per minute (rpm). More preferable is a screw speed of less than 150 rpm and most preferable is a screw speed of less than 120 rpm. The process window is limited to 380° F. to 470° F. melt temperatures. A more preferred melt temperature is between 390° F. and 450° F. Most preferred is a melt temperature between 400° F. and 425° F.

The antimicrobial material can further be used to produce molded parts by an injection method. Using the above antimicrobial material produced molding compound, the resin contains no more than 1% moisture by weight. Preferably, the moisture content is less than 0.4% and, most preferably, less than 0.1%. This resin can then be fed to an injection molder along with optional other additives. A suitable range of melt temperatures for molding compounds is 380° F. to 485° F., more preferably 380° F. to 470° F. and most preferably 430° F. to 470° F.

The antimicrobial material can also be used to produce sheet product by an extrusion method. The antimicrobial compound is first dispersed by known methods into an acrylic carrier resin having a controlled moisture content. By weight, the resin contains no more than 1% moisture. Preferably, the moisture content is less than 0.4% and, most preferably, less than 0.1%. The resin may be made by any conventional method of polymerization including, but not limited to, emulsion, bulk, solution, bead and suspension methods. This resin can then be fed to an extruder along with the main acrylic resin. The extruder may be either a single screw extruder or a double screw extruder. The extruder screw speed is no more than 250 revolutions per minute (rpm). More preferable is a screw speed of less than 150 rpm and most preferable is a screw speed of less than 120 rpm. This combination is then forced through a sheet die and through a calendar roll system to form the sheet product. The process window is limited in terms of polymer viscosity and melt temperature, most preferably to compositions of 1.0 to 3.0 g/10 min melt flow rate (230° C.@ 3.8 kg load) and 380° F. to 470° F. melt temperatures. A more preferred melt temperature is between 380° F. and 450° F. Most preferred is a melt temperature between 380° F. and 425° F.

The antimicrobial material can also be used to produce film product by an extrusion or film calendar method. The antimicrobial compound is first dispersed by known methods into an acrylic carrier resin having a controlled moisture content. By weight, the resin contains no more than 1% moisture. Preferably, the moisture content is less than 0.4% and, most preferably, less than 0.1%. The resin may be made by any conventional method of polymerization including, but not limited to, emulsion, bulk, solution, bead and suspension methods. This resin can then be fed to an extruder along with the main acrylic resin. The extruder may be either a single screw extruder or a double screw extruder. The extruder screw speed is no more than 250 revolutions per minute (rpm). More preferable is a screw speed of less than 150 rpm and most preferable is a screw speed of less than 120 rpm. This combination is then forced through a sheet die and through a calendar roll system to form the film product. The film thicknesses is in the range of 0.01 to 0.5 mm, most preferably between 0.02 and 0.08 mm.

The antimicrobial compositions can also be used to produce sheet product. The antimicrobial compound is first dispersed into a carrier acrylic resin. This resin can then be dissolved in either the MMA monomer or a pre-polymerized MMA syrup. This syrup can then be poured into cells for curing per well known cell casting methods. In much the same procedure, the material can also be used to produce a sheet product of the continuous cast method where the syrup is poured and cured between two moving polished steel belts. The mold curing may be carried out a temperatures in the range of 440°-500° F., preferably 440° to 475° F. and most preferably 440° to 460° F.

The antimicrobial compositions can also be used to produce many other products in addition to molding compound, molded parts, sheet and film may be formed by the processes described above. For example, extruded profiles, thermoformed and fabricated articles and foam products

The following Examples are set forth for purposes of illustration only and are not to be construed as limitations on the present invention except as set forth in the appended claims. All parts and percentages are by weight unless otherwise indicated. All parts and percentages are by weight and all temperatures are degrees Celsius unless explicitly stated otherwise.

### EXAMPLES

The products were characterized using standard testing procedures, as follows:

Properties typically certified for medical grades of the CYROLITE® family from Evonik Cyro LLC;

Silver ion release rates, by a modified procedure: Silver availability and silver ion release rates were measured by extraction of injection molded chips in purified water. A single chip (dimensions 2″×3″×⅛″) was extracted in 100 ml for 24 hours. The amount of silver in the extract solution was recorded by inductively coupled plasma spectrometry; and

Biological efficacy, following the JIS Z 2801 test for antimicrobial activity of plastics, now also ISO 22196.

The following abbreviations are used in the Tables that follows:
Moist. %=weight percent of H₂O in a sample, measured by Karl Fischer titration;
T %=Light transmission, % visible light (400 nm-700 nm) through a 3 mm thick sample;
YI=Yellowness Index, measured by ASTM D-1003;
H %=Haze percent, measured by ASTM D-1003; (Use of a hazemeter or spectrophotometer).
L*=L* coordinate of CIELAB Color Scale;
b*=b* coordinate of CIELAB Color Scale;
R=Silver release rate in 24 hours in nanogram/cm². Indicates amount of biologically effective silver available in the final product. It is an indication of antimicrobial performance;
Melt Flow=Melt flow rate in grams/10 minutes at 230° C. and 5.0 kg loading, except where otherwise indicated;
Ref=In reflectance
N.A.=Not Applicable
N.T.=Not Tested
opq=opaque
S.a.=Staphylococcus aureus;
P.a.=Pseudomonas aeruginosa;
S.c.=Salmonella choleraesius
ATCC=American Type Culture Collection

Both composition and process conditions were found to affect the product performance. We identified five critical parameters: additive loading level, presence of selected compounds, melt temperature, screw speed, and moisture content of feed resins, or alternatively, compounded final product. The effects are manifested in product appearance (discoloration) and antimicrobial activity, or alternatively, silver ion release rates. The underlying changes have not been clearly identified. We speculate that the combination of extruder heat, shear, moisture, and certain compounds result in fast silver activation during compounding that prematurely consumes the biologically effective silver available in the final product. The effects of these parameters are illustrated in the following examples. All grades used were Evonik Cyro LLC acrylic based polymer or multi-polymer compounds.

To evaluate the type of base resin, an antimicrobial additive was compounded into several acrylic resins, in natural, transparent, and opaque colors. Some representative examples are as follows:

TABLE 1

| Sample Code | Base Resin |
|---|---|
| 1.1 | ACRYLITE ® 8N acrylic polymer |
| 1.2 | ACRYLITE ® H12 acrylic polymer |
| 1.3 | ACRYLITE ® H15 acrylic polymer |
| 1.4 | ACRYLITE ® L40 acrylic polymer |
| 1.5 | ACRYLITE ® hw55 acrylic polymer |
| 1.6 | ACRYLITE ® FT15 acrylic polymer |
| 1.7 | ACRYLITE ® Resist ZK6BR impact acrylic polymer |
| 1.8 | ACRYLITE ® Resist ZK-X impact acrylic polymer |
| 1.9 | CYROLITE ® G20 EF acrylic-based multipolymer |
| | compound |
| 1.10 | CYROLITE ® G20 HIFLO ® acrylic-based |
| | multipolymer compound |
| 1.11 | CYROLITE ® GS-90 acrylic-based multipolymer |
| 1.12 | CYROLITE ® CG-97 acrylic-based multipolymer |
| | compound |
| 1.13 | CYROLITE ® Med 2 acrylic-based multipolymer |
| | compound |
| 1.14 | XT ® Polymer 250 acrylic-based multipolymer |
| | compound |
| 1.15 | XT ® Polymer 375 acrylic-based multipolymer |
| | compound |
| 1.16 | XT ® Polymer X800RG acrylic-based multipolymer |
| | compound |
| 1.17 | CYREX ® 200-8005 acrylic-polycarbonate alloy |

All trademarks are trademarks of Evonik Cyro LLC, Parsippany, NJ, USA

### Example 1

Table 2 illustrates the antimicrobial activity of some of the above base resins with 1.5%, by weight of a silver-based antimicrobial glass powder. In all examples, antimicrobial activity was measured per JIS Z 2801 and calculated as: [log(B/A)−log(C/A)]=[log(B/C)] where:

A=average number of viable cells of bacteria immediately after inoculation on an untreated test piece;
B=average number of viable cells of bacteria on the untreated test piece after 24 hours; and
C=average number of viable cells of bacteria on the antimicrobial test piece after 24 hours.

TABLE 2

| | Antimicrobial Activity | |
|---|---|---|
| Sample | P.a. | S.c. |
| Code | ATCC 9027 | ATCC 10708 |
| 1.3 | >6.5 | >6.3 |
| 1.7 | >5.9 | >5.9 |
| 1.11 | >6.7 | >6.5 |
| 1.13 | >6.7 | >6.5 |
| 1.16 | >6.7 | >6.5 |
| 1.17 | >6.7 | >6.5 |

### Example 2

Table 3 illustrates the loading effect of antimicrobial additive. The loading is expressed as active ingredient in weight % per total weight of composition. All samples used a silver-based antimicrobial glass powder in CRYOLITE® G20-HiFlo.

TABLE 3

| | | | | | | | | S.a. | P.a. |
|---|---|---|---|---|---|---|---|---|---|
| Sample | | T, | | | | | | ATCC | ATCC |
| Code | Loading | % | YI | H | L* | b* | R | 6538 | 9027 |
| 1 | 0 | 87.5 | −1.0 | 7.5 | 95 | −0.5 | 0 | 0 | 0 |
| 2 | 0.25 | 85.5 | 2.6 | 10.5 | 94 | 1.8 | 2.1 | 0.6 | 0.3 |
| 3 | 0.5 | 83.3 | 6.6 | 12.7 | 93 | 4.4 | 4.8 | >6.0 | >6.0 |
| 4 | 1.0 | 80.0 | 13 | 18 | 91.5 | 8.8 | 9.7 | >6.0 | >6.0 |
| 5 | 1.5 | 77.0 | 20 | 25 | 90 | 13.1 | 22.7 | >6.0 | >6.0 |
| 6 | 2.0 | 74.4 | 23 | 29 | 88.8 | 15.6 | 27.1 | N.T. | 4.6* |
| 7 | 2.5 | 72.6 | 25 | 35 | 87.9 | 16.9 | 35.8 | >6.0 | >6.0 |
| 8 | 3.0 | 70.0 | 29 | 40 | 86.5 | 19.2 | 47.0 | N.T. | >6.1* |
| 9 | 4.0 | 70.0 | 31 | 48 | 86.5 | 20.6 | 61.4 | N.T. | >6.1* |
| 10 | 5.0 | 65.3 | 37 | 54 | 84 | 25 | 73.6 | N.T. | >6.1* |

*= Different sample set for JIS Z 2801 testing only. Inoculation at 0, 24 hours, 48 hours and 72 hours. Viable count reading after 96 hours.

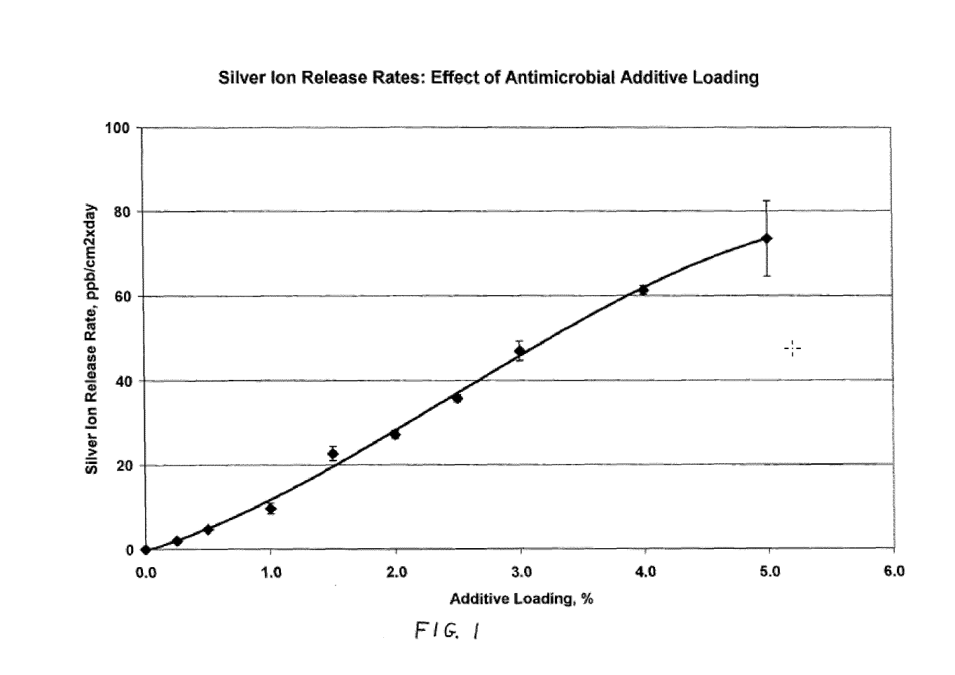

As seen, the properties depend on the loading of antimicrobial additive. Optics and silver ion release rates were measured on ⅛″ thick 2″×3″ injection molded chips. Silver ion release rates and antimicrobial activity are in good correlation with additive loading. Most of the compositions showed strong antimicrobial effect, with termination rate in excess of 6 orders of magnitude (R>6.0) for both organisms tested. FIG. 1 illustrates the effect of additive loading on the silver release rate. Sufficient silver should be present so that the release rate during compounding does not reduce the silver content below that require to pass a specified efficacy test (either JIS Z 2801 or as specified by a customer). However, excess silver is not desired as that raises the cost of the product.

### Example 3

Table 4 illustrates the effect of moisture. All samples were at 2.5% loading.

TABLE 4

| | Moist- | Barrel | T, | | Haze, | | | |
|---|---|---|---|---|---|---|---|---|
| Sample | ure % | ° F. | % | YI | % | L* | b* | R |
| 1 | 0 | 480 | 48.6 | 39.7 | 35.5 | 74.5 | 24.2 | 44.1 |
| 2 | 0.08 | 480 | 51.8 | 37.6 | 35.7 | 76.5 | 23.1 | 38.4 |
| 3 | 0.66 | 480 | 52.1 | 40.6 | 35.2 | 76.6 | 25.2 | 36.5 |
| Control | | | 87.5 | −0.9 | 6.4 | 95 | −0.43 | 0 |

Control = Resin without dilution 0% lonpure

As seen, the moisture content during extrusion can significantly affect the product properties. Losses of up to 17% silver release rates have been recorded, depending on moisture content and melt pool temperatures.

### Example 4

Table 5 illustrates the effect of barrel temperature, screw speed and melt temperature during compounding. All samples at 2.5% IonPure in CYROLITE® G20-HiFlo.

TABLE 5

| | Barrel | Screw | Melt | Melt | | | | | | | |
|---|---|---|---|---|---|---|---|---|---|---|---|
| | Temp. | Speed | Temp | Press | Torque | T | | Haze | | | |
| Sample | ° F. | rpm | ° F. | psi | lb-ft | % | YI | % | L* | b* | R |
| 1 | 380 | 60 | 438 | 720 | 72 | 74.7 | 28.8 | 37.2 | 88.8 | 19.8 | 45.3 |
| 2 | 390 | 60 | 450 | 680 | 69 | 73.9 | 30.2 | 37.5 | 88.4 | 20.7 | 40.9 |
| 3 | 400 | 60 | 450 | 600 | 60 | 74.3 | 28.6 | 37.5 | 88.6 | 19.5 | 42.5 |
| 4 | 420 | 60 | 452 | 470 | 50 | 73.2 | 29.1 | 37.4 | 88.1 | 19.8 | 40.6 |
| 5 | 440 | 60 | 478 | 350 | 40 | 71.4 | 30.3 | 39.4 | 87.2 | 20.5 | 38.2 |
| 6 | 460 | 60 | 490 | 280 | 33 | 65.5 | 33.5 | 36.2 | 84.2 | 22.2 | 33.6 |
| 7 | 480 | 60 | 500 | 190 | 32 | 58.7 | 38.8 | 41.1 | 80.5 | 25.3 | 42.9 |
| 8 | 500 | 60 | 510 | 160 | 28 | 46.4 | 45.9 | 39.9 | 73 | 28.4 | 33.9 |
| 3 | 400 | 60 | 450 | 600 | 60 | 74.7 | 28.8 | 37.2 | 88.8 | 19.8 | 42.5 |
| 9 | 400 | 90 | 450 | 460 | 59 | 70.3 | 35.9 | 38.9 | 86.5 | 24.8 | 41.3 |
| 10 | 400 | 120 | 457 | 420 | 54 | 68.3 | 41 | 36.7 | 85.5 | 28.7 | 35.9 |
| 11 | 400 | 150 | 465 | 370 | 50 | 63.3 | 43.5 | 36.7 | 82.9 | 30 | 35.4 |
| 12 | 400 | 180 | 465 | 350 | 48 | 60.4 | 52.1 | 36.6 | 81.2 | 37 | 32.7 |
| 13 | 380 | 180 | 460 | 390 | 50 | 61 | 51.7 | 36.3 | 81.5 | 36.8 | 32.7 |
| 11 | 400 | 150 | 465 | 370 | 50 | 63.3 | 43.5 | 36.7 | 82.9 | 30 | 35.4 |
| 14 | 420 | 120 | 485 | 340 | 44 | 66.2 | 41.5 | 39 | 84.4 | 28.8 | 40 |
| 15 | 440 | 90 | 482 | 330 | 42 | 68 | 36.9 | 38.8 | 85.4 | 25.3 | 38.9 |
| 16 | 460 | 60 | 492 | 280 | 38 | 67 | 33.4 | 39.4 | 85 | 22.4 | 40.9 |

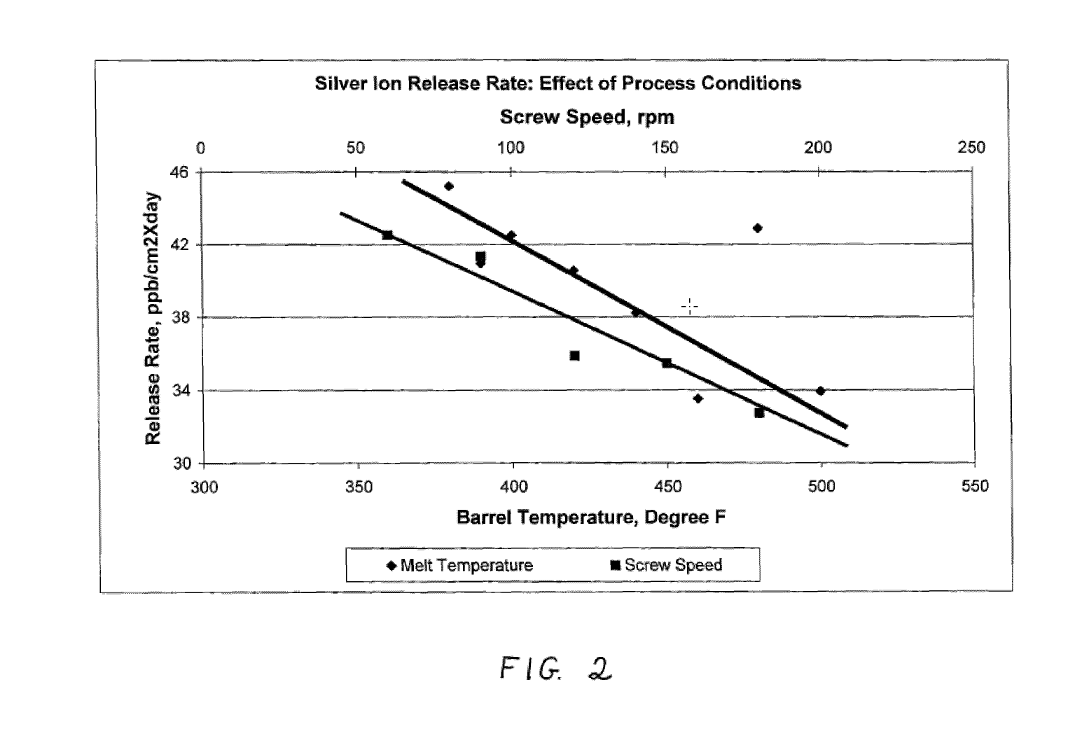

As seen, the barrel temperature and screw speed during melt compounding affects the optical properties and the silver release rate of the product. FIG. 2 illustrates the effects of barrel temperature and screw speed on the release rate. It is desirable to maximize the available silver by increasing the available silver in the extruded product. This may be achieved by minimizing the silver release rate during compounding. This is done by compounding at the lowest screw speed and lowest barrel temperature that within the process parameters for a specific polymer. If either the screw speed or the barrel temperature is too low, the viscosity of the melt becomes too high for processing.

### Example 5

Table 6 reports the effect of the base resin, antimicrobial loading level and moisture. All samples with the silver-based antimicrobial glass powder as summarized in Table 1. Antimicrobial activity following JIS Z 2801 for 24 hours.

TABLE 6

| | | | | | | Tensile | Mod- | Melt | | | P.a. | S.c. |
|---|---|---|---|---|---|---|---|---|---|---|---|---|
| Sample | Ion | | T, | | Haze | Strength | ulus | Flow | | | ATCC | ATCC |
| Code | pure | Moist. | % | YI | % | kpsi | kpsi | g/10 m | L* | b* | 9027 | 10708 |
| 1.3-1 | 0 | | 92.0 | 0.1 | 0.2 | 11.1 | 440 | 2.11 | 96.9 | 0.11 | 0 | 0 |
| 1.3-2 | 1.5 | N.T. | 78.0 | 16.4 | 59 | 10.8 | 447 | 2.76 | 90.5 | 10.6 | >6.5 | >6.3 |
| 1.3-3 | 2.5 | N.T. | 75.3 | 18.5 | 74 | 11.2 | 447 | 2.99 | 89.2 | 11.9 | >6.5 | >6.3 |
| 1.7-1 | 0 | | 89.7 | −0.7 | 1.1 | 6.8 | 242 | 1.36 | 95.9 | −0.3 | 0 | 0 |
| 1.7-2 | 1.5 | N.T. | 76.0 | 19.0 | 49.5 | 6.8 | 252 | 1.23 | 89.6 | 12.4 | >5.9 | >5.9 |
| 1.7-3 | 2.5 | N.T. | 63.7 | 29.0 | 74 | 7.2 | 257 | 1.35 | 83.3 | 18.5 | >5.2 | >5.9 |
| 1.11-1 | 0 | | 89.0 | −0.3 | 3.0 | 6.3 | 430 | 6.5 | — | — | 0 | 0 |
| 1.11-2 | 1.5 | 0.07 | 70.3 | 36.1 | 25.4 | 6.8 | 315 | 5.3 | 86.6 | 21.0 | >6.7 | >6.5 |
| 1.11-3 | 2.5 | 0.01 | 62.8 | 48.8 | 40.1 | 6.7 | 319 | 5.2 | 82.6 | 28.0 | >6.7 | >6.5 |
| 1.13-1 | 0 | | 85.0 | −1.0 | 7.0 | 5.32 | 250 | 2.1 | — | — | 0 | 0 |
| 1.13-2 | 1.5 | 0.0 | 63.7 | 42.5 | 29.0 | 5.26 | 230 | 1.35 | 83.0 | 23.0 | >6.7 | >6.5 |
| 1.13-3 | 2.5 | 0.07 | 51.1 | 54.8 | 39.0 | 5.26 | 235 | 1.72 | 76.0 | 28.0 | >6.7 | >6.5 |
| 1.16-1 | 0 | | 86.0 | −1.0 | 5.0 | 6.3 | 430 | 11 | — | — | 0 | 0 |
| 1.16-2 | 1.5 | 0.14 | 64.0 | 50.0 | 28.0 | 6.7 | 306 | 6.62 | 83 | 29.5 | >6.7 | >6.5 |
| 1.16-3 | 2.5 | 0.0 | 50.7 | 62.2 | 43.0 | 6.6 | 301 | 8.43 | 76 | 34.5 | >6.7 | .6.5 |
| 1.17-1 | 0 | | opq | N.A. | N.A. | 8.0 | 320 | 3.5* | ref | ref | 0 | 0 |
| 1.17-2 | 1.5 | 0.0 | opq | N.A. | N.A. | 7.7 | 308 | 3.2* | 89.2 | 5.3 | >6.7 | >6.5 |
| 1.17-3 | 2.5 | 0.07 | opq | N.A. | N.A. | 7.7 | 316 | 3.5* | 83.8 | 6.5 | >6.7 | >6.5 |

*= 3.8 kg loading

### Example 6

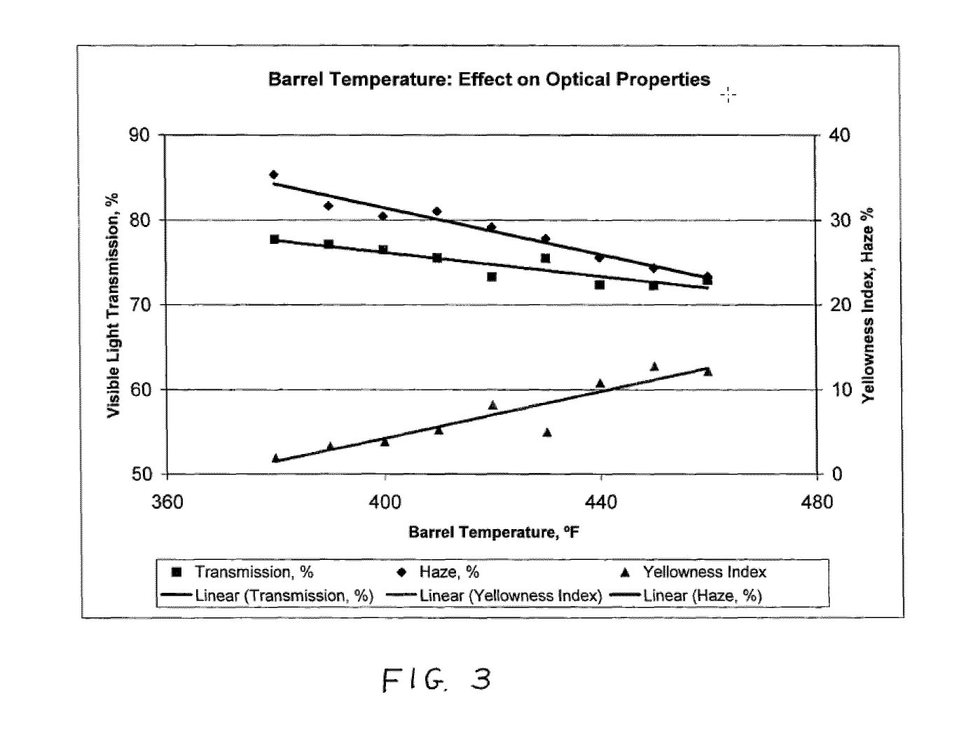

The antimicrobial compositions were also studied in injection molding under different process conditions, as illustrated in Table 7 and FIG. 3. A significant effect of molding temperature was apparent, with a specific discoloration of the material. The findings are important for guiding processors in the design of their process conditions.

TABLE 7

| | Feed | Barrel | Mold | | | | | |
|---|---|---|---|---|---|---|---|---|
| | Temp. | Temp. | Temp. | T, | | Haze, | | |
| Sample | ° F. | ° F. | ° F. | % | YI | % | L* | b* |
| 1 | 360 | 380 | 120 | 77.7 | 1.9 | 35.3 | 90.6 | 5.4 |
| 2 | 370 | 390 | 120 | 77.1 | 3.3 | 31.7 | 90.3 | 6.1 |
| 3 | 380 | 400 | 120 | 76.5 | 3.9 | 30.4 | 90.0 | 6.6 |
| 4 | 390 | 410 | 120 | 75.6 | 5.3 | 31.0 | 89.6 | 7.1 |
| 5 | 400 | 420 | 120 | 73.3 | 8.2 | 29.2 | 88.5 | 8.6 |
| 6 | 410 | 430 | 120 | 75.5 | 5.0 | 27.8 | 89.6 | 7.0 |
| 7 | 420 | 440 | 120 | 72.4 | 10.8 | 25.6 | 88.0 | 10.1 |
| 8 | 430 | 450 | 120 | 72.3 | 12.8 | 24.4 | 87.9 | 11.4 |
| 9 | 440 | 460 | 120 | 72.9 | 12.1 | 23.4 | 88.2 | 11.0 |
| 10 | 450 | 470 | 90 | 72.0 | 13.7 | 25.1 | 87.8 | 11.9 |
| 11 | 460 | 480 | 90 | 70.6 | 16.1 | 27.2 | 87.0 | 13.1 |
| 12 | 470 | 490 | 90 | 71.2 | 15.7 | 26.3 | 87.3 | 12.8 |
| 13 | 480 | 500 | 90 | 68.4 | 20.4 | 29.8 | 85.9 | 15.2 |

### Example 7

Although antimicrobial additives have an effect on the optical properties and the impact resistance of the feed base resins, the balance of properties are not significantly changed. Exemplary properties are listed in Table 8 that recites typical values of selected properties, comparison between CYROLITE® G20 HIFLO and its composition with 2.5% of the silver-based antimicrobial glass powder as an additive.

TABLE 8

| | | | ASTM | Typical Value | |
|---|---|---|---|---|---|
| Properties | Parameter | Unit | Standard | Control | Product |
| Mechanical Properties | | | | | |
| Tensile strength | | psi | D 638 | 7,000 | 6,870 |
| Tensile modulus | | ksi | D 638 | 370 | 318 |
| Tensile elongation @ yield | | % | D 638 | 3.6 | 3.0 |
| Tensile elongation @ break | | % | D 638 | 9.5 | 6.8 |
| Flexural strength | | psi | D 790 | 9,400 | 9,830 |
| Flexural modulus | | ksi | D 790 | 310 | 325 |
| Notched Izod | ¼″ bar, 23° C. | ft-lb/in | D 256 | 1.9 | 1.3 |
| Notched Izod | ¼″ bar, 0° C. | ft-lb/in | D 256 | 1.1 | 1.0 |
| Rockwell hardness | | M scale | D 785 | 27 | 40 |
| Thermal Properties | | | | | |
| Vicat softening point | | ° F. | D 1525 | 214 | 213 |
| Deflection temperature, | | ° F. | D 648 | 186 | 175 |
| annealed | | | | | |
| Coeff. linear thermal | 32-312° F | in/in/° F. | D 696 | 0.0000514 | |
| expansion | | | | | |
| Rheological Properties | | | | | |
| Melt flow rate | 230° C. & 5 kg | g/10 min | D 1238 | 10.0 | 10.0 |
| Optical Properties | | | | | |
| Light transmission | | % | D 1003 | 89.0 | 52 |
| Haze | | % | D 1003 | 6.0 | 41 |
| Yellowness index | | | CYRO TM | −0.3 | 17 |
| Other Properties | | | | | |
| Specific gravity | | | D 792 | 1.11 | |
| Water absorption | | % max | D 570 | 0.3 | |
| Bulk density | | g/cc | D 1895 | 0.65 | 0.54 |

While the invention has been described above with reference to specific embodiments thereof, it is apparent that many changes, modifications, and variations can be made without departing from the inventive concept disclosed herein. Accordingly, it is intended to embrace all such changes, modifications and variations that fall within the spirit and broad scope of the appended claims. All patent applications, patents and other publications cited herein are incorporated by reference in their entirety.

What is claimed is:

1. A method for producing an acrylic material having a desired transparency and antimicrobial efficacy, comprising the steps of:
combining a polymer selected from the group consisting of acrylic-based polymers, acrylic multipolymers, impact modified acrylic based polymers, acrylic based polymer blends and mixtures thereof with an antimicrobial additive and, optionally, other with additives to form a melt pool;
melt blending said melt pool wherein one or more of melt blending equipment, screw configuration, residence time, screw speed, melt temperature and moisture content of said melt pool is maintained within a predetermined range; and
solidifying said melt-blended melt pool to form said acrylic material with said desired transparency and antimicrobial efficacy.

2. The method of claim 1 wherein the melt blending step utilizes an extruder at a screw speed not exceeding 250 rpm.

3. The method of claim 2 wherein said screw speed is less than 150 rpm.

4. The method of claim 2 wherein said melt blending step is at a temperature in the range of 390° F. to 470° F.

5. The method of claim 4 wherein said melt blending step is at a temperature in the range of 400° F. to 425° F.

6. The method of claim 4 wherein said the melt blending step utilizes said polymer which has a controlled moisture content not exceeding 1%, by weight.

7. The method of claim 6 wherein said moisture content is less than 0.1% by weight.

8. The method of claim 2 wherein the resin components that include said polymer are formed by a polymerized by a method selected from the group consisting of emulsion, bulk, solution, bead and suspension.

9. The method of claim 2 wherein said antimicrobial additive is selected from the group consisting of silver-based antimicrobial agents, including silver zeolite products, silver containing compounds of tetravalent metals, such as titanium, zirconium and tin, antimicrobial glass compositions, and nanosilver additives.

10. The method of claim 9 wherein said antimicrobial additive is added in an amount of from 0.1% to 10%, by weight, of the final composition.

11. The method of claim 9 wherein said antimicrobial additive is added in an amount of from 0.3% to 2.5%, by weight, of the final composition.

12. The method of claim 10 wherein the resin components are further combined with an impact strength imparting additive.

13. The method of claim 12 wherein said impact strength imparting additive is selected from the group consisting of low Tg polymers and copolymers of aliphatic esters of acrylic acid, polymers and copolymers of 1,3-butadiene, styrene/butadiene, styrene/isoprene and styrene/ethylene-butylene copolymers, EPDM rubbers, polyisobutylene, polyurethane and silicone rubbers.

14. The method of claim 10 wherein the resin components are further combined with one or more auxiliary additive effective to promote antioxidation, flow, mold release, color, UV-stability, gamma stability, resistance to chemicals or static dissipative properties.

15. The method of claim 10 wherein said acrylic material is formed into an antimicrobial products selected from the group consisting of medical devices and accessories, including check valves, luer connectors, filter housings, spikes, Y-sites, measuring cups, etc., and consumer applications like vacuum cleaners, paper towel dispensers, hand dryers, bathtubs, shower stalls, bathroom and kitchen flooring.

16. The method of claim 11 wherein said melt blended melt pool is pelletized into pellet.

17. The method of claim 16 wherein said pellets are injected into an injected parts.

18. The method of claim 17 wherein said injection molding temperature in the range of 380° F. to 485° F.

19. The method of claim 18 wherein said injection molding step is at a temperature in the range of 430° F. to 470° F.

20. The method of claim 16 wherein said pellets are extruded into an extruded sheet, film, extruded profiles or foam products

21. The method of claim 16 wherein said pellets are formed into thermoformed articles.

22. A method for producing an acrylic molding compound having a desired transparency and antimicrobial efficacy, comprising the steps of:
combining an, acrylic multipolymers with an antimicrobial additive and, optionally, with other additives to form a melt pool;
melt blending said melt pool wherein one or more of melt blending equipment, screw configuration, residence time, screw speed, melt temperature and moisture content of said melt pool is maintained within a predetermined range; and
forced the combination through a extruder die and a pelletizer to form the molding compound product with said desired transparency and antimicrobial efficacy.

23. The method of claim 22 wherein the melt blending step utilizes an extruder at a screw speed not exceeding 250 rpm.

24. The method of claim 23 wherein said screw speed is less than 150 rpm.

25. The method of claim 22 wherein said melt blending step is at a temperature in the range of 380° F. to 470° F.

26. The method of claim 25 wherein said melt blending step is at a temperature in the range of 400° F. to 425° F.

27. The method of claim 25 wherein said the melt blending step utilizes said polymer which has a controlled moisture content not exceeding 1%, by weight.

28. The method of claim 27 wherein said moisture content is less than 0.1% by weight.

29. The method of claim 27 wherein said antimicrobial additive is selected from the group consisting of silver-based antimicrobial agents, including silver zeolite products, silver containing compounds of tetravalent metals, such as titanium, zirconium and tin, antimicrobial glass compositions, and nanosilver additives.

30. The method of claim 29 wherein said antimicrobial additive is added in an amount of from 0.1% to 10%, by weight, of the final composition.

31. The method of claim 29 wherein said antimicrobial additive is added in an amount of from 0.3% to 2.5%, by weight, of the final composition.

32. The method of claim 22 wherein said acrylic material is formed into an antimicrobial products selected from the group consisting of medical devices and accessories, including check valves, luer connectors, filter housings, spikes, Y-sites, measuring cups, etc., and consumer applications like vacuum cleaners, paper towel dispensers, hand dryers, bathtubs, shower stalls, bathroom and kitchen flooring.

33. The method of any one of claims 22 wherein said melt temperature and said barrel temperature are both selected at a minimum that maintains a combination viscosity suitable for said extruder die.
